(19) United States
(12) Patent Application Publication
(10) Pub. No.: US 2004/0050188 A1
(43) Pub. Date: Mar. 18, 2004

(54) Portable sensor

(75) Inventors: Ann Lee Richards, Pleasant Grove, UT (US); Dean F. Richards, Pleasant Grove, UT (US); Robert D. Richards, Pleasant Grove, UT (US); James F. Richards, Pleasant Grove, UT (US)

Correspondence Address: David B. Dellenbach, WORKMAN NYDEGGER & SEELEY, P.O. BOX 45862, SALT LAKE CITY, UT, 84145, US

(73) Assignee: Sparky Industries, Inc.

(21) Appl. No.: 10/244,100

(22) Filed: Sep. 13, 2002

(51) Int. Cl. G01D 7/00

(52) U.S. Cl. 73/866.3

(57) ABSTRACT

A portable sensor includes (i) a housing; (ii) one or more sensing devices, such as a video camera and/or a gas sensor (iii) a transmitter, electrically coupled to the sensing device(s) for transmitting a signal generated by the sensing devices; and (iv) a power source electrically coupled to, and for supplying electrical power to, the sensing devices, and the transmitter. The sensor is particularly useful for surveillance, inspections, medical emergencies and a variety of different settings in which remote transmission of inspected images is desired.

### BACKGROUND OF THE INVENTION

1. The Field of the Invention

The present invention relates to portable sensors. More particularly, the present invention relates to a portable sensor that is modular in nature, contains a variety of different components, and can be employed in a number of different settings.

2. The Relevant Technology

Sensors of one type or another have existed for thousands of years. Thousands of years ago, the first “sensors” were the unlucky individuals sent down into a cave or hole to personally investigate the area. A few thousand years ago, miners discovered that certain birds would quit singing in the presence of deadly natural gas escaping into a tunnel. This method of detection was still used into the early 20^{th} century. With the advent of computers, sensors have become complex and capable of carrying out a wide range of functions. Sensors are now available to detect radiation from virtually the entire range of the electromagnetic spectrum.

Sensors are also useful to detect gases, both moving through the atmosphere and concentrated in a closed environment, such as tunnels and caves. Early detection of certain gases leaking into closed systems is not only highly desired, but in some instances may actually save human life. Certain sensors can even detect the presence of various types of chemicals or electrolytes in a liquid.

Remote sensors, i.e., sensors that allow a person in one location to gain some knowledge of conditions in another, remote location, have been available for many years. However, these sensors have invariably been highly specialized, bulky, and difficult to use. There is a need in the art for sensors which are small, portable, and modular so that they can be used in a wide range of applications and environments without requiring any major modifications.

### BRIEF SUMMARY OF THE INVENTION

The present invention is directed to a portable sensor comprising, e.g., a video camera and/or other sensing device such as a gas sensing device. The sensor is modular and therefore capable of sensing a wide range of phenomena. The sensor is lightweight, self-contained and may be self-powered. A built in light source also enables the sensor to optionally act as a flashlight.

In one embodiment, the sensor is capable of sensing a wide range of the electromagnetic spectrum as well as a variety of gases. The sensor has the capability to transmit the sensed data back to a remote site via a specially designed transmitter, such as a transmitter comprising a wireless computer network card, and/or cellular telephone technology. A user holding the sensor can sense one or more phenomena at a given location and conveniently transmit the results to a different location.

In a preferred embodiment of the invention, the sensor has a housing having a handle coupled thereto. At least one sensing device, such as a video camera and/or a gas sensing device, is housed by the housing. Objects housed by the housing may be located within the housing or be attached to the housing. Optionally, multiple sensing devices are employed. Additionally, the wireless transmitter is housed by the housing and is electrically coupled to the sensing device, for transmitting the sensory data generated by the sensing device. The wireless transmitter may be capable of transmitting the data at different frequencies and/or different power levels selectable by the user. A power source is electrically coupled to, and supplies electrical power to, the sensing device, transmitter, a display and/or other additional components.

The sensor has a number of different sensing devices which may be used, either separately or in combination, within the housing. The sensing devices may be sensitive to electromagnetic radiation, from extremely low frequency radio waves to gamma radiation, including visible, ultraviolet and infrared light. They may be sensitive to sound at frequencies both above, within and below the range of human hearing.

The sensing devices may be sensitive to particular chemicals, including, but certainly not limited to oxygen, ozone, carbon dioxide, carbon monoxide, hydrogen sulfide, petroleum distillates of all sorts, other volatile chemical compounds, or any other natural or manmade gases which might be found intentionally or accidentally in the environment. They may also be sensitive to motion.

In one embodiment, the sensing device is a video camera and the transmitter is configured to transmit an image received by the video camera to a remote display, such as a computer monitor, via a wide range of possible transmission mechanisms. Such transmission mechanisms may include, for example, the internet, satellite, microwave, cellular telephones or other means yet to be developed.

One contemplated use of the invention includes having an inspector transmit an image of an inspection site, such as a house or other property, to a property owner located at a remote location. Also contemplated is the use of the invention to transmit the image of a patient in an ambulance to a remote hospital, including relevant vital statistics on the patient, such as blood pressure, heart rate, electrocardiogram information, etc. This can allow a hospital to be ready for the patient when the patient finally arrives for treatment.

Another contemplated use is for inspection of gas leaks, wherein the inspector transmits to a remote location an image of the area generally surrounding the leak, e.g., a broken pipe, and further transmits an indication of the type of gas that is leaking. However, these are only a few of the examples of the variety of different uses that may be employed by the present invention.

These and other objects and features of the invention will become more fully apparent from the following description and appended claims, or may be learned by the practice of the invention as set forth hereinafter.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are, therefore, not to be considered limiting of its scope, the invention will be described and explained with additional specificity and detail through the use of the accompanying drawings in which:

FIG. 1 is an exploded perspective view of one embodiment of a portable sensor depicting a typical arrangement of the parts of the sensor.

FIG. 2 is a rear perspective view of the embodiment of FIG. 1 in an operational configuration.

FIG. 3 provides a schematic view of the embodiment of FIG. 1 showing second and third optional additional sensing devices 22, 23 (shown in phantom lines), with an optional charging port location (also shown in phantom lines).

FIG. 4 is a perspective rear view of the sensor of FIG. 1 having alternate light source configurations, i.e., having a first and second light emitting diodes 30a (LED) instead of the array of LEDs 30 illustrated in FIG. 1.

FIGS. 5a-5d are schematic top views representing a handle of the sensor moving from a locked substantially perpendicular position to a locked substantially parallel position. FIG. 5a represents the handle in a locked substantially perpendicular position while FIG. 5b represents the movement of tabs on a springloaded button inwardly, thereby unlocking the handle. FIG. 5c represents the movement of the unlocked handle toward the substantially parallel position and FIG. 5d represents the handle in the locked substantially parallel position.

### DETAILED DESCRIPTION OF THE PREFERRED EMBODIMENTS

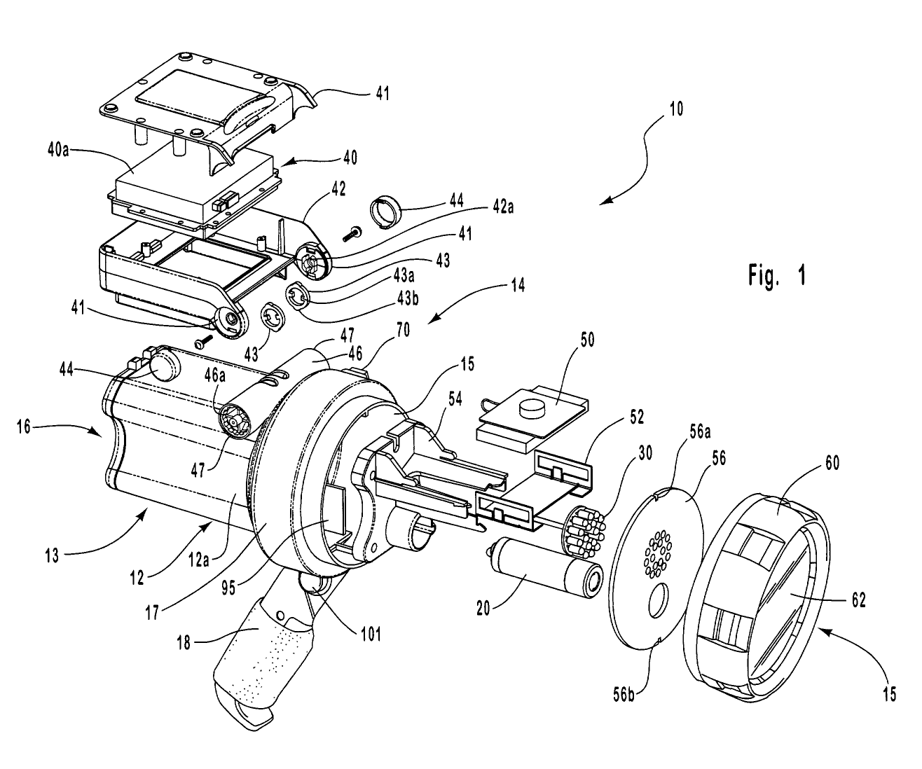

The invention is generally directed to a portable sensor 10 which, in the embodiment of FIG. 1 is designed to be small, compact, lightweight, and hand held. Sensor 10 has a housing 12 having a handle 18 coupled thereto and having one or more sensing devices 20 mounted therein.

As discussed in detail below, the sensing devices employed in the present invention may be any of a number of different types, including, but not limited to electromagnetic radiation, gas, or motion sensing devices, and/or a microphone. Sensor 10 further contains a transmitter 50, electrically coupled to one or more sensing devices 20 for transmitting the sensory data generated by the sensing device 20 to a remote location. A speaker may be attached to the housing and electrically coupled to the sensor and/or the wireless transmitter. The sensory data may also be shown on a handheld display 40 mounted on housing 12, display 40 comprising a monitor having a screen so that the user can view the output of one or more sensing devices. The displayed sensory data may include, for example, an image of an object viewed by a camera, data reflecting the type and/or qualities of a gas or other sensed medium, medical information, or other information sensed by a sensing device.

In the embodiment of FIG. 1, sensor 10 further has a built-in light source 30 in order to illuminate objects sensed by a sensor such as a video camera and/or in order to selectively act as a flashlight. This is highly advantageous because the user can investigate objects in a variety of different manners, e.g., by illuminating them for visual inspection, by engaging in camera inspection, and by inspecting through a variety of other sensors. Sensor 10 further has a power source electrically coupled to, and for supplying electrical power to, the one or more sensing device(s) 20, the transmitter 50, and, if present, the built-in light source 30 and display 40.

Certain examples of various sensing devices include a camera, a gas sensing device, a motion detector and other sensors. Some specific embodiments of the remote sensor are discussed in additional detail below.

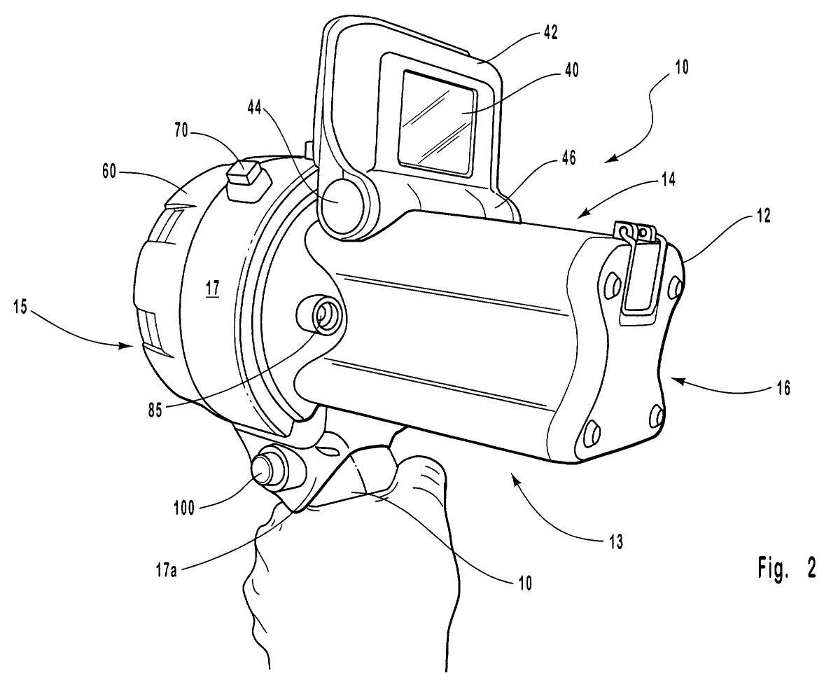

With continued reference to the exploded view of FIG. 1, sensor 10 includes a housing 12 having a main body 12a having a top 14, a bottom, a front 15, a back 16 (FIG. 2), a right side 13 and a left side. The housing main body 12a shown in this embodiment comprises plastic. However, main body 12a may be made from any suitable material, including plastic, metal, wood, rubber or any synthetic material capable of providing structural support to the internal and external components. The housing may be any shape or size consistent with the size required to house the internal components, including tubular, spherical, cube shaped, etc. A collar 17 of housing 12 couples a handle 18 to main body 12a of housing 12.

Housing 12 further comprises (i) a heat resistant mounting plate 56, made from a material such as Lexan®, which maintains certain parts such as light source 30 and sensing device 20 in desired positions near the front of the housing; (ii) a lens 62 comprising a transparent or translucent material such as glass, plexiglass, polycarbonate or another type of transparent or translucent material; and (iii) a bezel 60 configured to couple (e.g., threadedly couple) the lens 60 to the main body 12a.

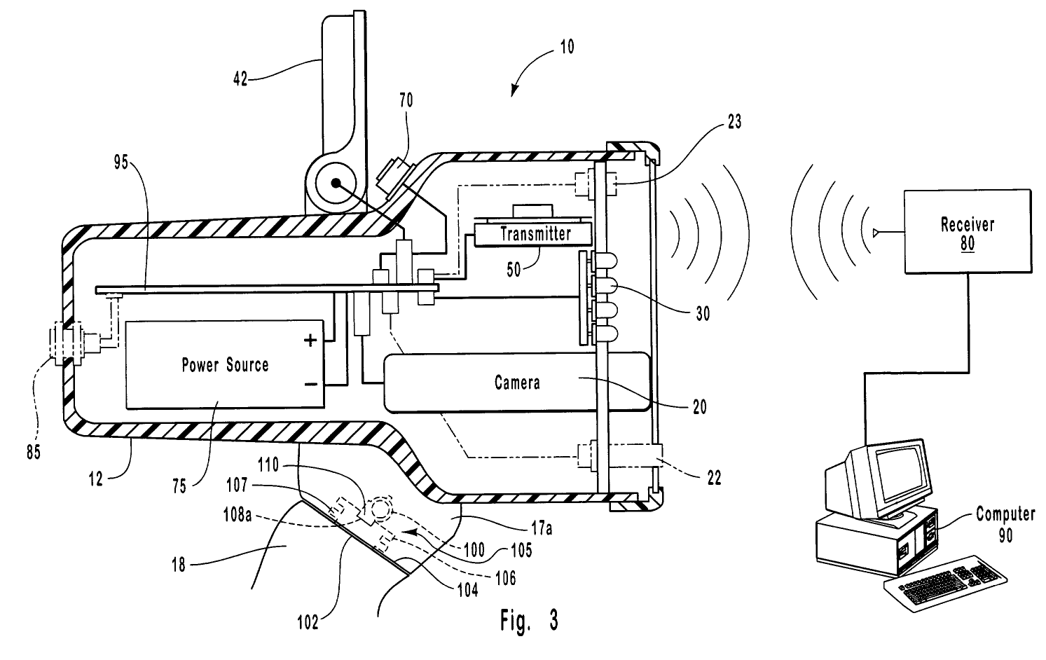

Mounting plate 56 has holes therein, as depicted in FIGS. 1 and 3, that correspond to and at least partially receive the sensing device 20 and light source 30 therein in order retain these components in a fixed position behind the lens 62, such that they are protected from water and other elements, but are also properly aligned so as to face forward so as to properly perform their desired functions. In one embodiment, plate 56 has upper and lower grooves 56a, 56b that fit into respective tabs on housing main body 12a to thereby maintain plate 56 snugly within housing 12 and substantially parallel to lens 62. Sensing device 20 and light emitting diode (LED) light source 30 may be affixed and/or at least partially inserted into mounting plate 56. In one embodiment, a seal surrounds the periphery of lens 62, such as a circular rubber seal.

Sensing device 20 and light emitting diode (LED) light source 30 are also coupled to mounting bracket 54. The light source may optionally comprise any of the light bulbs currently available, such as a flashlight bulb. The light source, such as one or more LEDs or one or more light bulbs may be employed to illuminate an object to be inspected. The LEDs may have focused lens portions on the ends thereof to focus the illumination therefrom forwardly. By enabling the user to optionally use sensor as a flashlight, the user is not required to carry a separate additional flashlight.

In one preferred embodiment, sensing device 20 is a compact video camera. The video camera could have various properties, including, but not limited to, properties such as zoom, infrared, ultraviolet, and low light level operational modes. Sensing device 20 in the form of a video camera is an example of video imaging means for generating a video signal of an object. In other embodiments, multiple sensors are provided within the housing. These other types of sensors are discussed in more detail below.

Transmitter 50 sits in holding tray 52, which attaches as a unit to mounting bracket 54. The transmitter might operate on a single frequency at a single power level, or it may be capable of operating on multiple frequencies at multiple power levels. Transmitter 50 can transmit at more than one power level. In one embodiment, the power level of the transmitter is at least 10 milliwatts. Mounting bracket 54 is designed to secure the power source 75 (see FIG. 3) as well as a circuit board 95 within the housing 12.

The embodiment shown in FIG. 1 further comprises a display 40. Display 40 comprises a monitor 40a coupled to housing 12 by being sandwiched between upper case portion 41 and lower case portion 42 of display 40. Lower case portion 42 pivotally attaches to hinge 46 on the top 14 of housing main body 12a using screws, for example. Hinge 46 may be attached to top 14 of main body 12a using mechanical or chemical fasteners, or it may be an integral part of the housing main body 12a. Display 40 is an example of display means electrically coupled to a sensing device (e.g., device 20) and a power source for displaying data sensed by the sensing device. Such data displayed may include, for example, an image of an object sensed by the sensing device (e.g., an object sensed by a video camera), qualities of certain substances sensed, medical information, or a variety of other phenomena sensed by a sensing device.

Display 40 may be an interactive display that is electrically coupled to the transmitter. Such an interactive display 40 is configured to receive input from a user operating the portable sensor, such that the input can be transmitted via the transmitter 50. For example, a user operating the sensor 10, equipped with a sensing device 20 in the form of a video camera, can highlight a portion of the image on the display 40 to emphasize a particular area. This may enable the user to emphasize a certain portion of the image on the display to a remote viewer, for example, in order to point exactly on the display to the location of a gas leak, or to view some other detail not immediately readily apparent from the transmitted image.

For instance, when the first sensing device 20 is a video camera, an inspector holding the sensor 10 may provide input to display 40 by circling or otherwise highlighting (e.g., with a stylus or other device) the image of a leaking pipe that appears in the screen of the display 40 and is leaking gas so that an individual viewing a transmitted image from a remote monitor can see the circle or other highlight and focus on the circled leaking pipe. An image of the circle is transmitted via the transmitter 50 to the remote monitor. Simultaneously, a second sensing device 22, such as a gas sensing device may be sensing the type of gas that is leaking, as well as the concentration and/or other qualities which may appear on the display 40 and be transmitted by transmitter 50 to the remote individual. Optionally, a third sensing device 23, such as a microphone may enable the inspector to communicate with the remote individual. Additionally, a speaker housed by the housing may enable the inspector to receive verbal feedback from the remote individual.

Thus, in an embodiment in which display 40 is interactive, display 40 is configured to receive input from a user operating the portable sensor (such as by highlighting of an image of an object viewed in the display) such that the input can be transmitted via the transmitter for viewing by a remote individual.

Display 40 may be a black and white or color display. It may be a self-contained unit, or it may be part of a personal digital assistant (PDA) which is integrated into the invention. The PDA could be used to replace the internal circuit board 95, or may be employed in addition to the circuit board. A PDA could also use integrated imaging software or other software designed to be used with other types of sensing devices to process the sensor information and send either the raw data, the processed information, or both to the receiving station via the transmitter 50. A PDA (or a portion thereof) is one example of an interactive display. Thus, in one embodiment, the interactive display is at least a portion of a personal digital assistant having an interactive display that is configured to receive input from a user operating the personal digital assistant.

Sensor 10 may optionally include a Global Positioning System (GPS) receiver incorporated into it to thereby allow a user to mark an exact position of an event being sensed. In one embodiment, sensor 10 includes a PDA having a GPS receiver incorporated into the PDA. Optionally, the GPS is independent from the PDA and is contained on or within the housing 12. In one embodiment, display 40 includes the components of the GPS receiver, such as the screen and circuitry employed for the GPS receiver. In such an embodiment, the GPS receiver is mounted on housing 12 as shown in FIG. 1. The GPS receiver may be used in a variety of different settings. For instance, in the example provided above relating to the gas leak, the GPS receiver may be employed to indicate to the remote individual where the inspector holding sensor 10 is as the inspector is inspecting the gas leak. In one embodiment, display 40 is configured to display objects viewed by the video camera (e.g., device 20), GPS sensory data, and/or sensory data received from sensing device 22 or another sensing device (such as data received from a gas sensing device, motion sensing device, medical sensing device, or a variety of different sensing devices, such as those disclosed herein). In one embodiment, display 40 comprises a PDA having a GPS receiver therein.

In the embodiment of FIG. 1, lower case portion 42 is hinged such that it may move in a ratcheting manner into sequential positions that range between a folded down position where display 40 sits flush with the housing 12 along top 14, to an essentially upright position in which it is substantially perpendicular to housing 12. In the embodiment of FIG. 1, in order to selectively lock display 40 into a desired position, opposing ratcheting members 43 couple to the inner portions of respective arms 41 of portion 42 and into selected positions within opposing toothed ends 47 of hinge 46.

Specifically, the inner tabs 43a of opposing ratcheting members 43 lock within respective corresponding grooves 42a in the arms of lower case portion 42. The outer tabs 43b thereof temporarily, movably lock into respective corresponding grooves formed between the teeth 46a that are dispersed in a circular array about the inner diameter of opposing sides 47 of hinge 46. Display 40 may ratchet from one position to another position by pivoting display 40 downward or upward, thereby causing outer tabs 43b to move into selected adjacent grooves between teeth 46a. Members 43 and teeth 46a may be made from plastic materials, for example.

Transmitter 50 may comprise a variety of different types of wireless transmission equipment, such as that developed under the IEEE 802.11, IEEE 802.11a and IEEE 802.11b wireless transmission standards, such as a wireless Ethernet card or digital cellular telephone equipment. Currently, such equipment might include, but is not limited to, Cellular Digital Packet Data (CDPD), Digital Broadcast Satellites, Switched Broadband, Local Multipoint Distribution Service (LMDS), Local Multipoint Communication Systems (LMCS), microwave and/or other wireless communication means. Transmitter 50 may comprise or be incorporated into a PDA.

The light source 30, sensing device 20 (and or sensing devices 22, 23), display 40, transmitter 50, and circuit board 95 are all electrically coupled to the power source 75 (See FIG. 3). The power source 75 may be a standard alkaline battery, or any hybrid, rechargeable type of battery, such as a lithium ion battery. If a rechargeable power source 75 is used, a recharging port 85 (see FIG. 2 or FIG. 3 in which port 85a is in an alternate location) may be added to housing 12 to allow for ease of recharging.

Sensing device 20 (and/or device 22, 23), display 40, transmitter 50, light source 30, and power source 75 are all electrically coupled to the circuit board 95, which is designed so that information from the sensing device(s) can be shown on the display 40 and/or transmitted to a remote location using transmitter 50. FIG. 3 illustrates in schematic form an example of possible wiring for these components. Optionally, the circuit board 95 may be eliminated and the components wired directly to each other, and/or to a PDA.

FIG. 2 shows the embodiment of FIG. 1 in an assembled, first operational position. Handle 18 has many advantages. It is possible for a user to grasp the handle 18 and conveniently view the image displayed by the display 40 and/or transmit the image via the transmitter to a remote viewer. In FIG. 2, handle 18 is shown in a first operational position, being substantially perpendicular to housing 12. As shown from the first operational position, a user may conveniently observe display 40 while orienting sensing device 20 towards the object or area to be sensed.

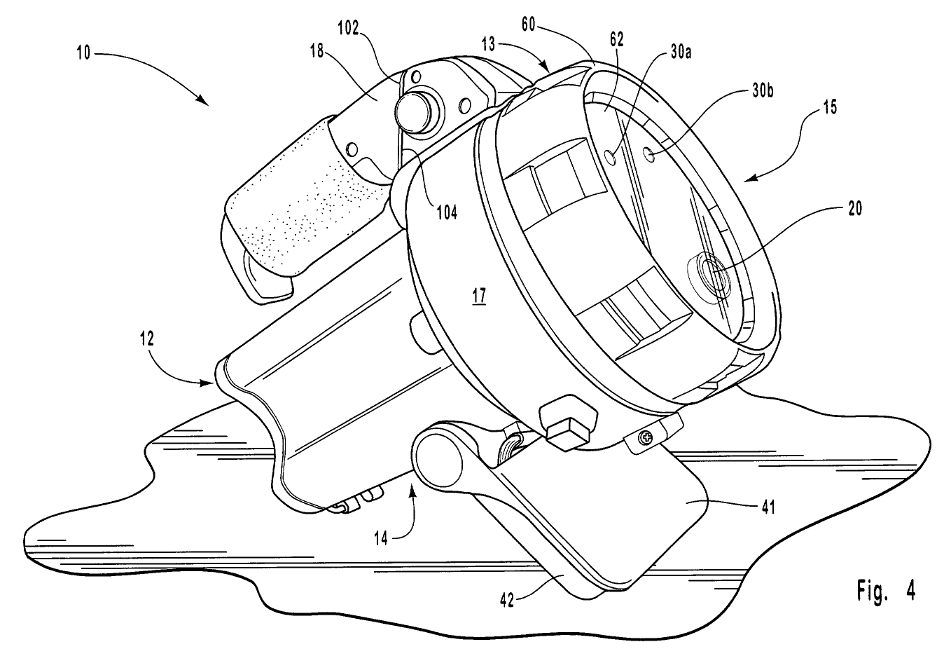

As mentioned, the first operational position of handle 18 (FIGS. 1-3) is substantially perpendicular with respect to the housing 12, and the second operational position (FIG. 4) of handle 18 is substantially parallel to the housing 12. By selectively pivoting handle into the substantially parallel position and resting the sensor 10 on a support surface such as a floor or the ground, as shown in FIG. 4, it is possible to orient the camera into a compact position that can be conveniently left over a long period of time for long-term inspection, such as in a walkway of a property for long-term inspection by a remotely located property owner in which images of the property are transmitted to the property owner. As shown in FIG. 4, while the display is in the substantially perpendicular position, the sensing device rests partially on the display 40 and partially on the housing 10 with the lens 62 facing upward for long term inspection of a hallway or other area.

FIG. 4 shows sensor 10 in the second operational position. Here, portable sensor 10 is placed on a support surface such that it rests on housing 12 and on display 40. When the unit is operational, with or without light source 30a (e.g., first and second light emitting diodes), display 40 is not visible from the front of the unit. This makes it easy and convenient to leave the unit sitting, for example on a desk or in a hallway, and, with the light source turned off, the unit appears to be a flashlight that is not turned on. Sensing device 20, whether visual or one of the other types of sensing devices associated with the invention, operates to send sensed data via the transmitter to a remote location where it may be processed and stored. Using a PDA, the information may also be processed and/or stored with the sensor for downloading later. This allows the sensor to operate in environments where having a person present at all times to manually work the invention may not be practical or desirable.

Returning to FIG. 2, an on/off switch 70 is located on collar 17. Alternately switch 70 could be on the handle 18, the display 40, or any other location. Switch 70 may operate the sensing device(s) and display 40 and/or light source 30. Optionally switch 70 operates the transmitter. Also optionally, the light source and/or transmitter may have a separate switch located elsewhere on the housing 12 or handle 18 and/or the display 40 may have its own switch, such as a switch mounted on the display 40. Each separate sensing device may also have its own switch.

Returning now to FIG. 3, optional second sensing device 22 and an optional third sensing device 23 are shown in phantom lines as being co-located in the housing 12. In this embodiment, sensing device 20 may represent a camera, while sensing device 22 may represent a gas sensing device and sensing device 23 may represent a microphone for picking up audible signals or other sensing device. Alternatively, one or both sensing devices 22, 23 may be some other type of electromagnetic sensing device, such as an infrared or ultraviolet camera, or a radiation sensing device, such as a Geiger counter, or any other electromagnetic radiation sensing device or a combination thereof. A speaker, (not shown) may also be incorporated into the invention to allow the inspector holding the sensor to hear the remote viewer.

The sensing device(s) 22 and/or 23 may comprise a gas sensing device designed to detect any number or type of gases, such as oxygen, ozone, carbon monoxide, carbon dioxide, radon, methane, hydrogen sulfide, lower explosion limits, upper explosion limits, or any other gas. The sensing device (e.g. device 22) may have an extendible wand, which protrudes out of the housing 12 to act as a “sniffer” for particular gases.

Sensing device(s) 22 and/or 23 can optionally be sensitive to sound or motion. Device 22 or 23 may optionally represent a medical sensing device to record, for example, blood pressure, heart rate, respiration and the like. Note that there is virtually no limit as to how many different sensing devices may be incorporated into the invention, except technological size and space limitations. There could be 1, 2, 3, 4, 5, 6, 7, 8, 9, 10 or more sensing devices incorporated into different embodiments of the invention.

Transmitter 50 sends a signal from one or more sensing devices 20, 22, or 23 to receiver 80. Transmitted information is then processed on computer 90. All of the electrically powered components of the sensor 10 may be electrically coupled to and powered by the power source 75, co-located in the housing 12.

Handle 18 is pivotally coupled to collar 17 of housing 12. Specifically, in the embodiment of FIG. 3, handle 18 is pivotally coupled to a lower base portion 17a of collar 17 (see also FIG. 2). Handle 18 has an angled portion 102 that interfaces with an angled portion 104 of collar base 17a. Consequently, when handle 18 pivots, it moves between a substantially perpendicular position with respect to the housing 12 and a substantially parallel position with respect to the housing 12.

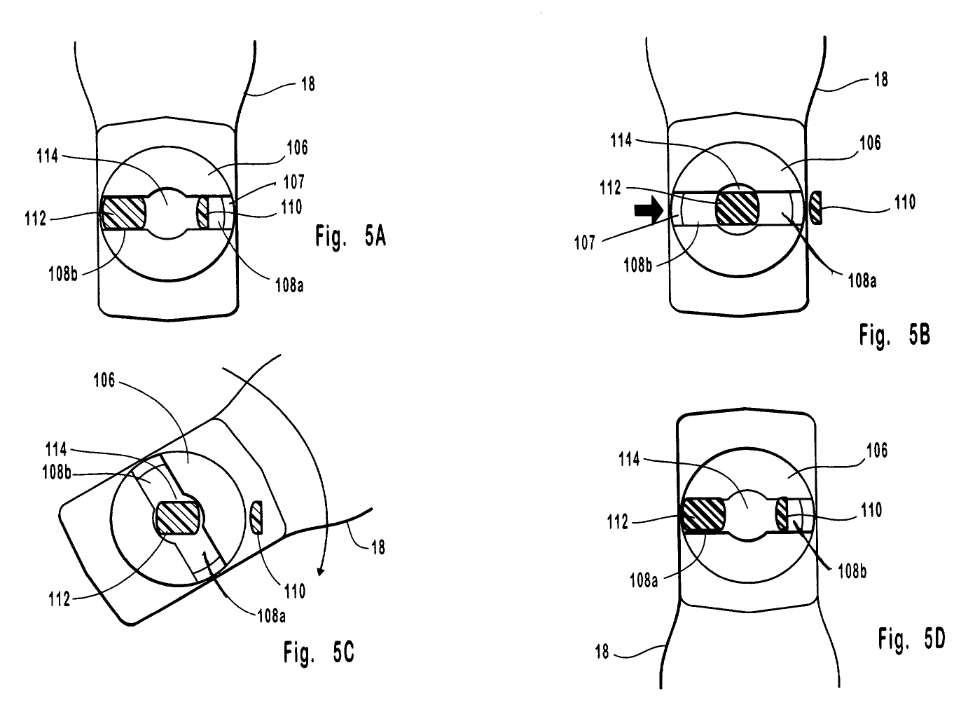

Handle 18 may be pivotally coupled to housing 12 in a variety of different manners. In the embodiment of FIG. 3, handle 18 includes a head 105 (shown in phantom lines in FIG. 3 and illustrated schematically in FIG. 5) that extends into and is pivotally coupled to collar base 17a. Head 105 has an upper rim 106 having first and second channels 108a, 108b therein and a lower annular rim 107. Rims 106 and 107 may each pivot on corresponding portions (e.g., a plate or ridge) of base 17a.

Handle 18 may be selectively locked into the substantially parallel or substantially perpendicular position in a variety of different manners. In one embodiment a spring loaded release button 100 shown in FIG. 2 and in phantom lines in FIG. 3 allows pivoting movement of handle 18 between the first operational position and the second operational position. Button 100 is an elongate hollow button having first and second tabs 110, 112 extending downwardly therefrom (see FIGS. 3, 5a-d) and having a spring (not shown) mounted therein biasing the button 100 outwardly away from base 17a. As illustrated in FIGS. 2, 3 and 5a, when the button 100 is in a nondepressed condition, tabs 110, and 112 extend downwardly from button 100 into respective first and second channels 108a, 108b of upper rim 106, thereby locking handle 18 into the substantially perpendicular position. FIG. 5a represents the handle 18 in the locked substantially perpendicular position of FIG. 3. Channels 110 and 112 converge into larger central channel 114.

As illustrated in FIG. 5b, upon depressing button 100, tabs 110, 112 of button 100 move sidewardly out of channels 108a, 108b and thereby unlocking handle 18. When tab 112 is in the larger central channel 114 and tab 110 is out of channel 108a, handle 18 can then be moved by the user toward the substantially parallel position, as shown in FIG. 5C. FIG. 5c represents the movement of the unlocked handle toward the substantially parallel position. Upon reaching the substantially parallel position, tabs 110, 112 of button 100 can snap into opposite channels 108b, 108a respectively. FIG. 5d thus represents the handle in the locked substantially parallel position.

Thus, when the button 100 is extended (i.e., non-depressed) as shown in FIGS. 2 and 5a, the tabs 110, 112 engage respective channels 108a, 108b and lock handle 18 into a fixed position. When button 100 is depressed (FIG. 5B), the tabs 110, 112 do not engage respective channels, but rather, allow movement (FIG. 5C) of the handle 18. As shown in FIG. 5d tabs 110, 112 snap back into opposite side channels and the handle 18 locks again.

In another embodiment, a springloaded detent allows movement of the handle but locks it into desired positions. However, a variety of other mechanisms may be employed for locking the handle into desired positions, such as those known in the art.

The structure 101 shown in FIG. 1 may be a cosmetic cover, for example.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A portable sensor comprising:
a housing;
a first sensing device housed by the housing;
a second sensing device housed by the housing;
a transmitter, electrically coupled to at least one of the first and second sensing devices for transmitting sensory data generated by the first and second sensing device; and
a power source electrically coupled to, and for supplying electrical power to, the first and second sensing devices and the transmitter.

2. The portable sensor of claim 1 wherein the first sensing device is a camera and the second sensing device is a gas sensing device.

3. The portable sensor of claim 1 wherein the second sensing device comprises a gas sensing device electrically coupled to the power source and the transmitter such that information from the gas sensing device may be transmitted via the transmitter.

4. The portable sensor of claim 1 wherein the first sensing device is a camera and the second sensing device is one of: (i) a gas sensing device; (ii) a motion sensing device; and (iii) a radiation sensing device.

5. The sensor of claim 4, wherein the radiation sensing device comprises a gieger counter.

6. The portable sensor of claim 1 wherein the sensing device comprises an electromagnetic radiation sensing device.

7. The portable sensor of claim 6 wherein the electromagnetic radiation sensing device comprises at least one of a radiation sensing device, a visible light sensing device, an ultraviolet light sensing device, and an infrared light sensing device.

8. The portable sensor of claim 7 wherein the sensing device is a visable light sensing device comprising a video camera capable of sensing an object and generating a video signal of the object.

9. The portable sensor of claim 8 wherein the video camera is a low light video camera capable of producing a video signal in low ambient light conditions.

10. The portable sensor of claim 1, further comprising a light source capable of illuminating the object.

11. The sensor of claim 10, wherein the light source comprises at least one light emitting diode.

12. The portable sensor of claim 1 further comprising display means electrically coupled to the sensing device and power source for displaying data sensed by the sensing device.

13. The portable sensor of claim 12, wherein the sensing device comprises a video camera configured to generate a video signal of an object and wherein the display means displays an image of the object sensed by the sensing device and wherein a signal from the sensing device is transmitted by the transmitter.

14. The portable sensor of claim 1 wherein at least one sensing device comprises a motion sensing device.

15. The portable sensor of claim 1 wherein at least one sensing device comprises a sound sensing device.

16. The portable sensor of claim 1 wherein at least one sensing device comprises a gas sensing device comprising at least one of an oxygen sensing device, a hydrogen sulfide sensing device, a carbon monoxide sensing device, a methane sensing device, a natural gas sensing device, an ozone sensing device, a radon sensing device and a carbon dioxide sensing device.

17. The portable sensor of claim 1 further comprising a personal digital assistant electrically coupled to the power source.

18. The portable sensor of claim 17, wherein at least one sensing device comprises video imaging means for generating a video signal of an object and wherein the personal digital assistant is electrically coupled to the video imaging means.

19. The portable sensor of claim 17 wherein the transmitter is an integral part of the personal digital assistant.

20. The portable sensor of claim 18 wherein the transmitter is a PCMCIA card inserted into a corresponding PCMCIA slot in the personal digital assistant.

21. The portable sensor of claim 17 wherein the personal digital assistant stores and manipulates the data.

22. The portable sensor of claim 1 wherein the transmitter is a cellular telephone.

23. The portable sensor of claim 22 wherein the cellular telephone is integrated into the personal digital assistant.

24. The portable sensor of claim 1 wherein the first sensing device is a camera and the second sensing device is a gas sensing device, and further comprising a third sensing device comprising a microphone.

25. A portable sensor comprising:
a housing;
a sensing device housed by the housing;
a transmitter, electrically coupled to the sensing device for transmitting sensory data generated by the sensing device;
a global positioning system receiver housed by the housing; and
a power source electrically coupled to, and for supplying electrical power to, the sensing device, the transmitter and the global positioning system receiver.

26. A portable sensor comprising:
a housing;
a first sensing device housed by the housing;
an interactive display, housed by the housing and electrically coupled to the sensing device for viewing the data collected by the sensing device;
a transmitter, electrically coupled to the sensing device and the interactive display for transmitting the sensory data generated by the sensing device,
wherein the interactive display is configured to receive input from a user operating the portable sensor, such that the input can be transmitted via the transmitter; and
a power source electrically coupled to, and for supplying electrical power to, the sensing device, the interactive display and the transmitter.

27. The portable sensor of claim 26 wherein the interactive display is electrically coupled to the transmitter and allows a user operating the portable sensor to highlight at least a portion of the image of the object viewed in the display such that an individual reviewing the sensory data can also view the highlighted portion of the image.

28. The portable sensor as recited in claim 26, wherein the interactive display is at least a portion of a personal digital assistant having: an interactive display that is configured to receive input from a user operating the personal digital assistant.

29. A portable sensor comprising:
a housing;
a light source housed by the housing;
video imaging means for generating a video signal of an object, the video imaging means being housed by the housing;
display means electrically coupled to the video imaging means for displaying an image of the object;
a transmitter, electrically coupled to the video imaging means for transmitting the video signal generated by the video imaging means; and
a power source electrically coupled to, and for supplying electrical power to, the video imaging means, the light source, the display means and the transmitter; and
a handle coupled to the housing for convenient grasping by the user, such that a user can grasp the handle and conveniently view the image displayed by the display means.

30. The portable sensor of claim 29, wherein the display is mounted on a top portion of the housing and a handle is coupled to a bottom portion of the housing such that a user holding the handle can conveniently view an image of an object within on the display.

31. The portable sensor of claim 30, wherein the handle selectively pivots between a position substantially parallel to the housing and a position substantially perpendicular to the housing.

32. The portable sensor of claim 29 wherein the display means is selectively positioned into a closed position and an open position and wherein the sensor is configured to rest partially on the display means and partially on the housing when the sensor is placed on a support surface.

33. A sensor as recited in claim 29, wherein the housing further comprises a heat resistant mounting plate within the housing, wherein the mounting plate is configured to maintain the video imaging means and light source in a desired position within the housing.

34. The portable sensor of claim 29 wherein the video imaging means comprises a video camera and the display means comprises a monitor having a screen for viewing by a user.

35. The portable sensor of claim 29, wherein the sensor selectively acts as a flashlight.
